(19) United States
(12) Patent Application Publication
(10) Pub. No.: US 2024/0321273 A1
(43) Pub. Date: Sep. 26, 2024

(54) SIGNAL PROCESSING DEVICE, SIGNAL PROCESSING METHOD, AND SIGNAL PROCESSING PROGRAM

(71) Applicant: NIPPON TELEGRAPH AND TELEPHONE CORPORATION, Tokyo (JP)

(72) Inventors: Hiroshi SATO, Musashino-shi, Tokyo (JP); Tatsuya KAKO, Musashino-shi, Tokyo (JP)

(73) Assignee: NIPPON TELEGRAPH AND TELEPHONE CORPORATION, Tokyo (JP)

(21) Appl. No.: 18/575,327

(22) PCT Filed: Jul. 2, 2021
(86) PCT No.: PCT/JP2021/025207

§ 371 Date: Dec. 29, 2023

(51) Int. Cl. G10L 15/22; G10L 25/51; G10L 25/87

(52) U.S. Cl. CPC G10L 15/22; G10L 25/51; G10L 25/87

(57) ABSTRACT

A signal processing device includes circuitry configured to receive, together with a voice recognition result of an utterance section of an utterance input to each of a plurality of microphones, an input of time information of a start time and an end time of each utterance and information regarding an appearance time of each word in the voice recognition result; detect whether there is an overlap in time of utterance sections in each pair of voice recognition results by combining voice recognition results of two utterances from utterance sections of utterances input to each of the microphones; calculate a similarity of voice recognition result for each pair having an overlap in time of utterance sections; compare the similarity with a predetermined threshold; and reject an utterance having a shorter length of the voice recognition result as a wraparound utterance for a pair in which the similarity exceeds the threshold.

### TECHNICAL FIELD

The present invention relates to a signal processing device, a signal processing method, and a signal processing program.

### BACKGROUND ART

In recent years, with improvement in speech recognition performance, the adaptation region of speech recognition has been widened. For example, an application of voice recognition includes an application of voice recognition of a user utterance in an interaction such as a discussion or a meeting.

For example, as a method of recognizing an utterance of a user in a conference, there is a method of collecting a user's own voice by a device held by each user and recognizing the voice. In this case, for example, a microphone of a computer used by each user or a microphone connected to the computer is used to collect the voice.

In such a speech recognition application such as a conference, a voice of each user is collected by an individual device, is generally recognized by a server, and is provided to the user as meeting minutes or real-time subtitles.

In this case, in a situation where each speaker uses a microphone for recording his/her own voice, it is ideal that only the voice of the speaker is collected by the microphone held by a certain speaker.

However, in general, when a plurality of people hold a conference in the same space, a phenomenon that a voice of a certain speaker wraps around a microphone of another speaker and is collected frequently occurs. When such a phenomenon occurs, problems as follows occur.

First, when the voice of the certain speaker is recognized by a plurality of microphones, a plurality of voice recognition texts is output for the same content. For example, in a case where voices of speakers in microphones of four people are collected and recognized in a meeting where the four people face each other, a phenomenon occurs in which similar voice recognition results are displayed four times. Thus, readability of the voice recognition result is deteriorated, and usability is impaired.

Subsequently, when the voice of the certain speaker is recognized by a microphone of another speaker, a wrong label of a speaker is attacked to the text. Thus, reliability of the label of the speaker added to the voice recognition result decreases.

In the related art, a voice activity detection (VAD) technique exists and is widely used as a technique for detecting a section where a voice exists. However, the voice activity period detection technique is a technique for identifying a voice or a non-voice, and thus it is not possible to reject the voice of another speaker that should not be recognized as described above.

Therefore, in voice recognition, many techniques have been studied so far to deal with a wraparound of another speaker under a condition that a plurality of persons face each other and one microphone exists for each speaker.

For example, a technique described in Non Patent Literature 1 achieves rejection of a voice other than a speaker corresponding to a microphone by using a feature amount regarding relevance of signals between microphones, such as a ratio of energy between microphones, in addition to an acoustic feature amount. Further, the technique described in Non Patent Literature 2 achieves rejection of a voice other than a speaker corresponding to a microphone on the basis of a correlation between microphones.

However, these existing methods assume that signals of the microphones are synchronized, including a situation in which all the microphones are connected to the same audio interface, and are unsuitable for a condition that each speaker collects sounds on different devices.

On the other hand, Non Patent Literature 3 proposes a method in which signals of microphones are handled independently without assuming synchronization between microphones, and only a voice of a microphone wearer is extracted from a signal input using a deep neural network. However, in another literature, it has been pointed out that in a method of independently processing each microphone without using a signal of another microphone, performance deteriorates when only a voice of the wearer is detected. In addition, the technique described in Non Patent Literature 3 limits the device to be mounted, and is not suitable in a case of corresponding to a general microphone different for each user.

Non Patent Literature 4 proposes an algorithm for reducing overlap between speakers of a voice recognition result that occurs in a result of performing speaker diarization. The algorithm described in Non Patent Literature 4 compares voice recognition results of a pair of utterances having overlapping times from the start to the end of the utterance, and in a case where the matching rate of words of the voice recognition results exceeds a threshold, it is determined that both are voice recognition results corresponding to the same utterance, and the shorter voice recognition result is rejected. Thus, the algorithm described in Non Patent Literature 4 performs duplicate deletion of results in speaker diarization.

### CITATION LIST

### Non Patent Literature

Non Patent Literature 1: John Dines, Jithendra Vepa, Thomas Hain, “THE SEGMENTATION OF MULTI-CHANNEL MEETING RECORDINGS FOR AUTOMATIC SPEECH RECOGNITION”, IDIAP, 2006.
Non Patent Literature 2: K. Laskowski, Q. Jin, and T. Schultz, “Crosscorrelation-based Multispeaker Speech Activity Detection”. In Eighth International Conference on Spoken Language Processing, (2004).
Non Patent Literature 3: Amrutha Nadarajan, Somandepalli Krishna, and S. Narayanan Shrikanth, “SPEAKER AGNOSTIC FOREGROUND SPEECH DETECTION FROM AUDIO RECORDINGS IN WORKPLACE SETTINGS FROM WEARABLE RECORDERS”, ICASSP 2019-2019 IEEE International Conference on Acoustics, Speech and Signal Processing (ICASSP). IEEE, 2019.
Non Patent Literature 4: Shota Horiguchi, Yusuke Fujita, and Kenji Nagamatsu, “Utterance-Wise Meeting Transcription System Using Asynchronous Distributed Microphones”, arXiv preprint arXiv: 2007. 15868 (2020).

### SUMMARY OF INVENTION

### Technical Problem

In Non Patent Literature 4, a similarity s(wᵢ, wⱼ) of the voice recognition result is expressed by Expression (1).

$$\begin{matrix}[ Math . 1 ] & \\ s ( {w}_{i} , {w}_{j} ) = \frac{max ( \vert {w}_{i} \vert , \vert {w}_{j} \vert ) - d ( {w}_{i} , {w}_{j} )}{min ( \vert {w}_{i} \vert , \vert {w}_{j} \vert )} & ( 1 )\end{matrix}$$

In Expression (1), Wᵢ is a word string of an utterance i, and Wⱼ is a word string of an utterance j. |⋅| is the length of the word string. d(⋅) represents a Levenshtein distance.

However, in the technique described in Non Patent Literature 4, since the wraparound voice is recognized in fragments, there is a constraint that the voice recognition tends to be erroneously converted. Thus, when words mixed with kana and kanji are compared with each other, the similarity is often not calculated correctly. Specific examples thereof include “miayamatta (misread)” and “yamatta (and wait)”.

The present invention has been made in view of the above, and an object of the present invention is to provide a signal processing device, a signal processing method, and a signal processing program capable of rejecting a voice recognition result caused by a voice of another speaker wrapping around in a case where each speaker has a microphone and voice recognition of a voice collected by the microphone is performed.

### Solution to Problem

In order to solve the above-described problems and achieve the object, a signal processing device according to the present invention includes a first detection unit that receives, together with a voice recognition result of an utterance section of an utterance input to each of a plurality of microphones, an input of time information of a start time and an end time of each utterance and information regarding an appearance time of each word in the voice recognition result, and detects whether or not there is an overlap in time of utterance sections in each pair of voice recognition results of utterances obtained by combining voice recognition results of two utterances from voice recognition results of utterance sections of utterances input to each of the plurality of microphones, a calculation unit that calculates a similarity of voice recognition results for each pair having an overlap in time of utterance sections among pairs of the voice recognition results of the utterances in units of kana or phonemes, and a rejection unit that compares the similarity with a predetermined threshold for each pair having an overlap in time of the utterance sections, and rejects an utterance having a shorter length of the voice recognition result as a wraparound utterance for a pair in which the similarity exceeds the threshold.

### Advantageous Effects of Invention

According to the present invention, when each speaker has a microphone and voice recognition is performed on a voice picked up by the microphone, a voice recognition result caused by a voice of another speaker going around can be rejected.

### BRIEF DESCRIPTION OF DRAWINGS

FIG. 1 is a diagram schematically illustrating an example of a configuration of a signal processing device according to an embodiment.

FIG. 2 is a diagram schematically illustrating an example of a configuration of a wraparound utterance rejection unit illustrated in FIG. 1.

FIG. 3 is a flowchart illustrating a processing procedure of signal processing according to the embodiment.

FIG. 4 is a flowchart illustrating a processing procedure of wraparound utterance rejection processing illustrated in FIG. 3.

FIG. 5 is a diagram illustrating a performance evaluation result in a case where the signal processing device according to the embodiment is applied.

FIG. 6 is a diagram illustrating an example of a computer in which a program is executed and thus the signal processing device is implemented.

### DESCRIPTION OF EMBODIMENTS

Hereinafter, an embodiment of the present invention will be described in detail with reference to the drawings. Note that the present invention is not limited by this embodiments. Further, in the description of the drawings, the same portions are denoted by the same reference numerals.

### EMBODIMENT

In the present embodiment, by the following three processes, when each speaker has a microphone and voice recognition is performed on a voice collected by the microphone, a voice recognition result (wraparound utterance) caused by a voice of another speaker wrapping around is accurately rejected.

In the embodiment, voice recognition results of two utterances among voice recognition results collected by a plurality of microphones are combined into a pair, and the following three processes are performed for each pair having an overlap in time of the utterance sections among the pairs of voice recognition results of utterances.

In the embodiment, by performing similarity calculation processing not in units of words but in units of Kana or phonemes of the voice recognition result for a pair having an overlap in time of the utterance sections, robust comparison is achieved against errors based on erroneous conversion of the voice recognition result.

Furthermore, in the embodiment, the calculation processing of similarity in consideration of an overlap ratio of utterance sections for each utterance is performed for each pair having an overlap in time of the utterance sections, thereby reducing erroneous rejection of the wraparound utterance.

Furthermore, in the normal speech recognition, it is possible to calculate at which timing each word has occurred in the voice recognition result. In the embodiment, by using this, the processing of calculating similarity by comparing only the voice recognition result of a portion having the same appearance timing in the utterance for each pair having an overlap in time of the utterance sections is performed, thereby reducing erroneous rejection.

### [Signal Processing Device]

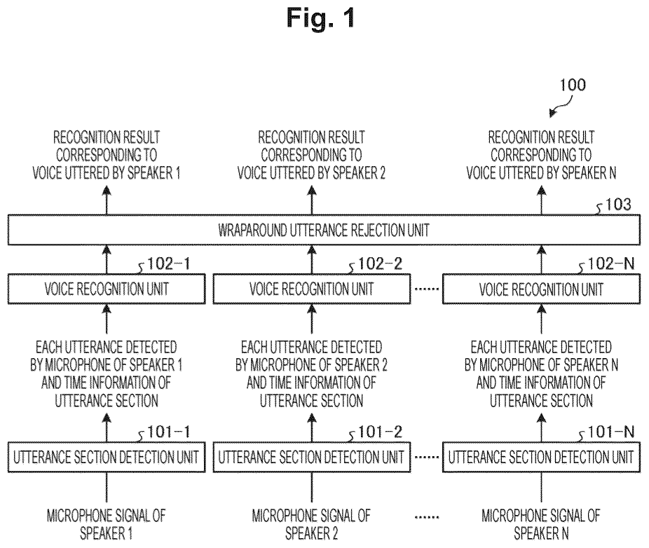

Next, the signal processing device according to the embodiment will be described. FIG. 1 is a diagram schematically illustrating an example of a configuration of the signal processing device according to the embodiment.

A signal processing device 100 according to the embodiment is implemented by, for example, a predetermined program being read by a computer or the like including a read only memory (ROM), a random access memory (RAM), a central processing unit (CPU), and the like, and the CPU executing the predetermined program. Furthermore, the signal processing device 100 includes a communication interface that transmits and receives various types of information to and from another device connected in a wired manner or connected via a network or the like.

Each of speakers 1 to N has a microphone, and the signal processing device 100 performs voice recognition of a voice (microphone signal) collected by the microphone. Note that the signal processing device 100 assumes time synchronization in units of several 100 ms. The signal processing device 100 includes utterance section detection units 101-1 to 101-N (second detection units), voice recognition units 102-1 to 102-N, and a wraparound utterance rejection unit 103.

The utterance section detection units 101-1 to 101-N detect and cut out an utterance section in which an utterance exists from each input continuous microphone signal using an utterance section detection technique. The utterance section detection units 101-1 to 101-N output voices in utterance sections of respective utterances to the corresponding voice recognition units 102-1 to 102-N, respectively. An existing utterance section detection technique can be applied to the utterance section detection units 101-1 to 101-N. In the utterance section detection units 101-1 to 101-N, processing of utterance section detection is performed on the microphone signals of the microphones 1, 2, . . . , and N. For example, an output of the utterance section detection unit 101-i (1≤i≤N) with respect to the microphone signal of the microphone i is the voice signal of each utterance j=1, 2, . . . , and M detected by the microphone i, and time information of a start time and an end time of the utterance.

The voice recognition units 102-1 to 102-N perform voice recognition on the voice in the utterance section of each utterance input from the utterance section detection units 101-1 to 101-N, respectively. An existing voice recognition technique can be applied to the voice recognition units 102-1 to 102-N. The voice recognition units 102-1 to 102-N output the voice recognition result to the wraparound utterance rejection unit 103. The output voice recognition result includes text of the voice recognition result and time information indicating at which time each word in the text is uttered, the time information corresponding to the text of the voice recognition result. That is, outputs of the voice recognition units 102-1 to 102-N are the text of the voice recognition result of each utterance section of the utterance input to the microphone of each of the speakers 1 to N, time information of a start time and an end time of each utterance and an appearance time of each word in the text of the voice recognition result.

The wraparound utterance rejection unit 103 detects an utterance that seems to have been wrapped around by the voice of another speaker on the basis of the text of the voice recognition result of each utterance section of the utterance input to each of the microphones 1 to N, time information of a start time and an end time of each utterance and information regarding an appearance time of each word in the voice recognition result, and rejects the utterance. The wraparound utterance rejection unit 103 obtains a voice recognition result for the utterance of each speaker by rejecting an utterance that is considered to be wraparound from the voice recognition result corresponding to each microphone.

From the voice recognition result of the utterance section of each utterance, the wraparound utterance rejection unit 103 detects whether or not there is an overlap in time of utterance sections in each pair of voice recognition results obtained by combining the voice recognition results of two utterances. Then, the wraparound utterance rejection unit 103 rejects an utterance that is considered to be wraparound by calculating similarity of the voice recognition results not in units of words but in units of Kana or phonemes for each pair having an overlap in time of the utterance sections among the pairs of voice recognition results of the utterance. Then, the wraparound utterance rejection unit 103 outputs a voice recognition result corresponding to the voice uttered by the speakers 1 to N.

### [Wraparound Utterance Rejection Unit]

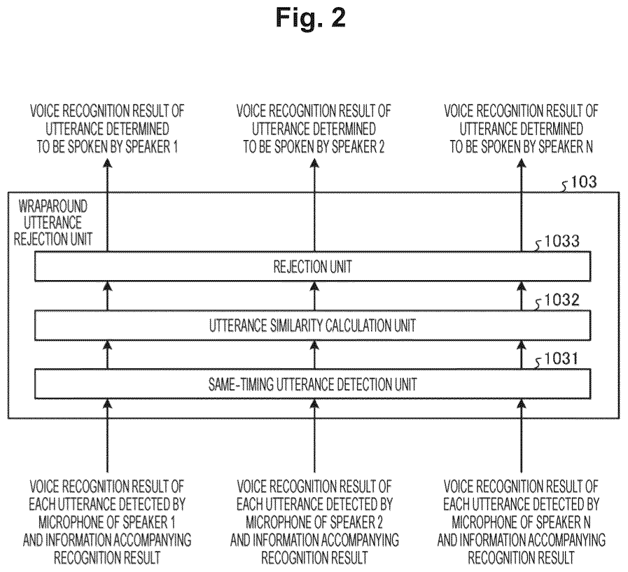

Next, the wraparound utterance rejection unit 103 will be described. FIG. 2 is a diagram schematically illustrating an example of a configuration of the wraparound utterance rejection unit 103 illustrated in FIG. 1. As illustrated in FIG. 2, the wraparound utterance rejection unit 103 includes a same-timing utterance detection unit 1031 (first detection unit), an utterance similarity calculation unit 1032 (calculation unit), and a rejection unit 1033.

The same-timing utterance detection unit 1031 receives a voice recognition result of each utterance section of an utterance input to each of the microphones 1 to N and information accompanying the voice recognition result from each of the voice recognition units 102-1 to 102-N. The information accompanying the voice recognition result is time information of a start time and an end time of each utterance and information regarding an appearance time of each word in the voice recognition result.

The same-timing utterance detection unit 1031 combines voice recognition results of two utterances from the voice recognition result of each utterance section of the input utterance into one pair. The same-timing utterance detection unit 1031 creates a plurality of pairs of voice recognition results of two utterances.

Then, the same-timing utterance detection unit detects whether or not there is an overlap in time of utterance sections for the pair of voice recognition results of the two utterances. This is because, in a combination of voice recognition results of utterances having an overlap in utterance times, there is a possibility that one voice recognition result is a wraparound voice. In a case where a start time and an end time of each utterance overlap with each other in the time information of the pair of voice recognition results of two each of input utterances, the same-timing utterance detection unit 1031 detects that there is an overlap in time of the utterance sections between the pair of voice recognition results of the two utterances.

Based on the detection result of the same-timing utterance detection unit 1031, the utterance similarity calculation unit 1032 calculates the similarity of the voice recognition results for each pair having an overlap in time of the utterance sections among the pairs of the voice recognition results, using a method to which the following first to third characteristics are applied. Note that all of the first to third characteristics can be applied, or each of the first to third characteristics can be applied alone.

As a first characteristic, the utterance similarity calculation unit 1032 calculates the similarity of the voice recognition result in units of Kana or phonemes by comparing Kana or phoneme strings of the voice recognition results of utterances as comparison targets. The utterance similarity calculation unit 1032 can achieve similarity calculation robust against errors based on erroneous conversion of the voice recognition result by comparing the voice recognition result not in units of words but in units of Kana or phonemes.

As a second characteristic, the utterance similarity calculation unit 1032 calculates the similarity using the overlap ratio of utterance sections for each utterance and adjusts the similarity, thereby avoiding calculation of a high similarity even in a case where only a small part of the utterances overlap.

As a third characteristic, the utterance similarity calculation unit 1032 achieves more robust comparison by calculating the similarity by comparing only portions determined to have been uttered at the same time in the voice recognition results by using the time information in which each word or Kana has occurred, the time information being obtained from the voice recognition results. Conventionally, even in a case where only a part of utterance sections of utterances as comparison targets overlap each other, the entire voice recognition results are compared with each other, and thus the similarity may be unreasonably high. On the other hand, the utterance similarity calculation unit 1032 calculates the similarity with higher accuracy by comparing only portions that can be determined to have been uttered at the same time in the voice recognition results.

The utterance similarity calculation unit 1032 calculates the similarity s(cᵢ, cⱼ) of the voice recognition result using, for example, Expression (2). Expression (2) applies all of the first to third characteristics.

$$\begin{matrix}[ Math . 2 ] & \\ s ( {c}_{i} , {c}_{j} ) = \frac{max ( \vert {c}_{i} \vert , \vert {c}_{j} \vert ) - d ( {c}_{i} , {c}_{j} )}{min ( \vert {c}_{i} \vert , \vert {c}_{j} \vert )} \cdot overlap ( {t}_{i} , {t}_{j} ) & ( 2 )\end{matrix}$$

In Expression (2), cᵢ and cⱼ are kana or phoneme strings of portions uttered at the time when both utterances overlap in the voice recognition results of the utterance i and the utterance j. Furthermore, overlap(tᵢ, tⱼ) indicates the overlap ratio of the utterance sections of the utterance i and the utterance j. The overlap ratio of the utterance sections can be, for example, a value obtained by dividing a length in which the utterances of the utterance i and the utterance j overlap by a length of a shorter one of the utterance i and the utterance j. d(⋅) is a distance between the voice recognition results, and for example, a Levenshtein distance or the like can be used. |⋅| indicates a length of a character string.

In Expression (2), the portion indicated by Expression (3) is a calculation expression indicating how many characters of the shorter voice recognition result match the longer voice recognition result among the overlapping utterances. overlap(tᵢ, tⱼ) is to weight the portion illustrated in Expression (3) with a temporal overlap ratio between utterance sections. In Expression (2), by applying this overlap(tᵢ, tⱼ), the similarity according to the actually overlapping ratio can be appropriately obtained.

$$\begin{matrix}[ Math . 3 ] & \\ \frac{max ( \vert {c}_{i} \vert , \vert {c}_{j} \vert ) - d ( {c}_{i} , {c}_{j} )}{min ( \vert {c}_{i} \vert , \vert {c}_{j} \vert )} & ( 3 )\end{matrix}$$

The rejection unit 1033 determines whether or not a wraparound utterance is included by comparing the similarity calculated for each pair with a predetermined threshold for each pair having an overlap in time of the utterance sections, and rejects the wraparound utterance. For a pair in which the similarity calculated by the utterance similarity calculation unit 1032 exceeds the threshold, the rejection unit 1033 determines an utterance having a shorter length of the voice recognition result as a wraparound utterance and rejects the utterance having a shorter length of the voice recognition result.

### [Processing Procedure of Signal Processing]

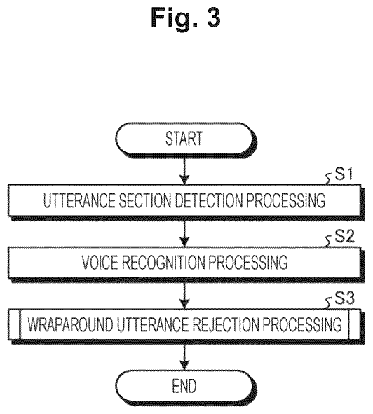

Next, signal processing executed by the signal processing device 100 will be described. FIG. 3 is a flowchart illustrating a processing procedure of signal processing according to the embodiment.

Upon receiving the input of the microphone signal collected by each of the microphones of the speakers 1 to N, the utterance section detection units 101-1 to 101-N perform utterance section detection processing of cutting out a section where an utterance exists from each of the input continuous microphone signals using the utterance section detection technique (step S1). The voice recognition units 102-1 to 102-N perform voice recognition processing on the voices in the respective utterance sections input from the respective utterance section detection units 101-1 to 101-N (step S2).

Then, the wraparound utterance rejection unit 103 performs wraparound utterance rejection processing of detecting an utterance that seems to have been wrapped around by the voice of another speaker and rejecting the utterance on the basis of the text of the voice recognition result of each utterance section of the utterance input to each of the microphones 1 to N, the time information of a start time and an end time of each utterance, and information regarding an appearance time of each word in the voice recognition result (step S3).

### [Processing Procedure of Wraparound Utterance Rejection Processing]

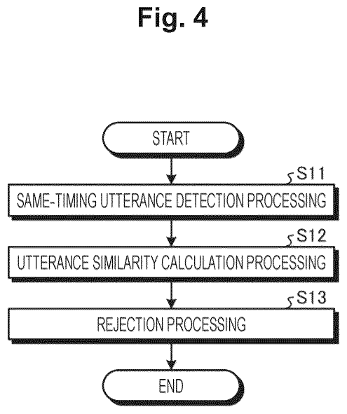

Next, the processing procedure of the wraparound utterance rejection processing (step S3) illustrated in FIG. 3 will be described. FIG. 4 is a flowchart illustrating a processing procedure of the wraparound utterance rejection processing illustrated in FIG. 3.

In the wraparound utterance rejection unit 103, when the voice recognition result of each utterance section of the utterance input to each of the microphones 1 to N and the information accompanying the voice recognition result are input from the voice recognition units 102-1 to 102-N, the same-timing utterance detection unit 1031 classifies the voice recognition result of each utterance section of the input utterance into a pair of voice recognition results of two utterances. The same-timing utterance detection unit 1031 performs a same-timing utterance detection processing of detecting whether or not there is an overlap in time of the utterance sections for the pair of voice recognition results of two each of utterances (step S11).

On the basis of the detection result by the same-timing utterance detection unit 1031, the utterance similarity calculation unit 1032 performs utterance similarity calculation processing of calculating the similarity of voice recognition results by comparing Kana or phoneme strings of the voice recognition results of the utterances as comparison targets with each other for each pair having an overlap in time of the utterance sections among the pairs of the voice recognition results of the utterances (step S12).

The rejection unit 1033 compares the similarity calculated for each pair with the predetermined threshold for each pair having an overlap in time of the utterance sections to determine whether or not a wraparound utterance is included, and performs the rejection processing of rejecting the wraparound utterance (step S13).

### [Evaluation Result]

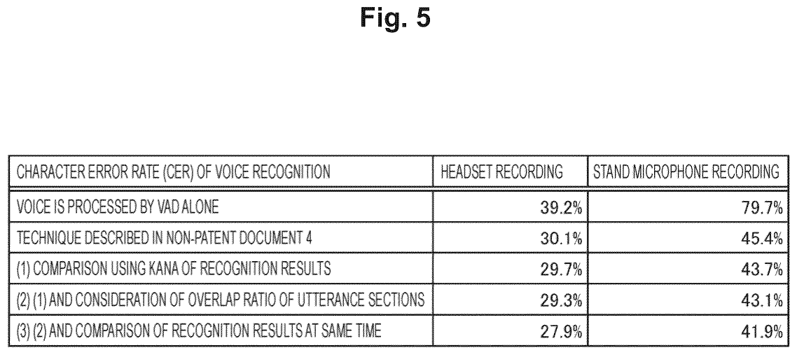

FIG. 5 is a diagram illustrating a performance evaluation result in a case where the signal processing device 100 according to the embodiment is applied. FIG. 5 illustrates a result of evaluating a character error rate (CER) of voice recognition. FIG. 5 illustrates evaluation results in a case where voice is processed by VAD alone and in a case where voice is processed using the technique described in Non Patent Literature 4.

(1) of FIG. 5 illustrates an evaluation result of a case (first characteristic) where, for a pair of voice recognition results of two utterances, the similarity is calculated in units of Kana of the voice recognition results and a wraparound utterance is rejected. (2) of FIG. 5 illustrates, in addition to (1) of FIG. 5, an evaluation result in a case where the similarity is calculated in consideration of the overlap ratio of utterance sections for each utterance, and the wraparound utterance is rejected (combination of the first and second characteristics). (3) of FIG. 5 illustrates, in addition to (2) of FIG. 5, an evaluation result in a case where the wraparound utterance is rejected by comparing the similarity between the voice recognition results of only portions determined to have been uttered at the same time in the voice recognition results (combination of the first to third characteristics).

As illustrated in FIG. 5, signal processing device 100 exhibits higher voice recognition performance in both cases of headset recording and stand microphone recording than in the case where voice is processed by VAD alone and in the case where the technique described in Non Patent Literature 4 is used. That is, the signal processing device 100 can appropriately reject the wraparound utterance. Then, in the signal processing device 100, it is possible to further improve the rejection accuracy of the wraparound utterance by applying the first to third characteristics.

### Effects of Embodiment

As described above, the signal processing device 100 according to the embodiment detects whether or not there is an overlap in time of utterance sections in each pair of voice recognition results of utterances obtained by combining voice recognition results of two utterances from voice recognition results of utterance sections of utterances input to each of the plurality of microphones. Then, the signal processing device 100 calculates the similarity of voice recognition results for each pair having an overlap in time of the utterance sections among the pairs of the voice recognition results of the utterances in units of kana or phonemes. Then, the signal processing device 100 compares the similarity with a predetermined threshold for each pair having an overlap in time of the utterance sections, and rejects an utterance having a shorter length of the voice recognition result as a wraparound utterance for a pair of voice recognition results of utterances whose similarity exceeds the threshold.

As described above, the signal processing device 100 performs the accurate similarity calculation processing not in units of words but in units of kana or phonemes of the voice recognition results for each pair having an overlap in time of the utterance sections. Thus, the signal processing device 100 can achieve robust comparison against errors based on erroneous conversion of the voice recognition results and reject the wraparound utterance with high accuracy.

Here, the technique described in Non Patent Literature 4 is an algorithm that compares and rejects utterances in which utterance sections overlap even slightly. For this reason, the technique described in Non Patent Literature 4 further has a constraint that there are some cases in which rejection is erroneously made even though only a part thereof is overlapped. For example, in a case where a certain speaker says “it's hard, right?” while another speaker says “it's hard” with a slightly overlapping utterance section, the technique described in Non Patent Literature 4 erroneously rejects the voice recognition result because the similarity between the voice recognition results is high.

On the other hand, the signal processing device 100 performs the similarity calculation processing in consideration of the overlap ratio of utterance sections for each utterance for each pair having an overlap in time of the utterance sections. Thus, the signal processing device 100 does not calculate a high similarity even in a case where only a small part of the utterance overlaps, and can reduce erroneous rejection of the wraparound utterance.

Then, in the technique described in Non Patent Literature 4, since only the degree of coincidence of words is considered and the appearance timing is not considered, there is a constraint that when a high similarity is calculated for words uttered at completely different timings in the same utterance, the words are erroneously rejected. For example, when comparing two voice recognition results of “did you see the movie?” and “yes, that movie”, even the “movies” actually uttered at different timings have been sometimes rejected since they are the same voice recognition results.

On the other hand, the signal processing device 100 has achieved reduction of erroneous rejection of the wraparound utterance by performing processing of calculating the similarity by comparing only portions determined to have been uttered at the same time in the voice recognition results for each pair having an overlap in time of the utterance sections.

Therefore, with the signal processing device 100 according to the embodiment, in a case where each speaker has a microphone and voice recognition is performed on a voice collected by the microphone, a voice recognition result caused by a voice of another speaker wrapping around can be appropriately rejected, and the performance of voice recognition can be improved.

### [System Configuration of Embodiment]

Each component of the signal processing device 100 is functionally conceptual, and does not necessarily have to be physically configured as illustrated. That is, specific forms of distribution and integration of the functions of the signal processing device 100 are not limited to the illustrated forms, and all or a part thereof can be functionally or physically distributed or integrated in any unit according to various loads, usage conditions, and the like.

Furthermore, all or any part of the processing performed in the signal processing device 100 may be implemented by a CPU, a graphics processing unit (GPU), and a program analyzed and executed by the CPU and the GPU. In addition, the processing performed in the signal processing device 100 may be implemented as hardware by wired logic.

Furthermore, among the processing described in the embodiment, all or a part of the processing described as being automatically performed can be manually performed. Alternatively, all or a part of the processing described as being manually performed can be automatically performed by a known method. The processing procedures, control procedures, specific names, and information including various data and parameters, as described and illustrated, can be appropriately changed unless otherwise specified.

### [Program]

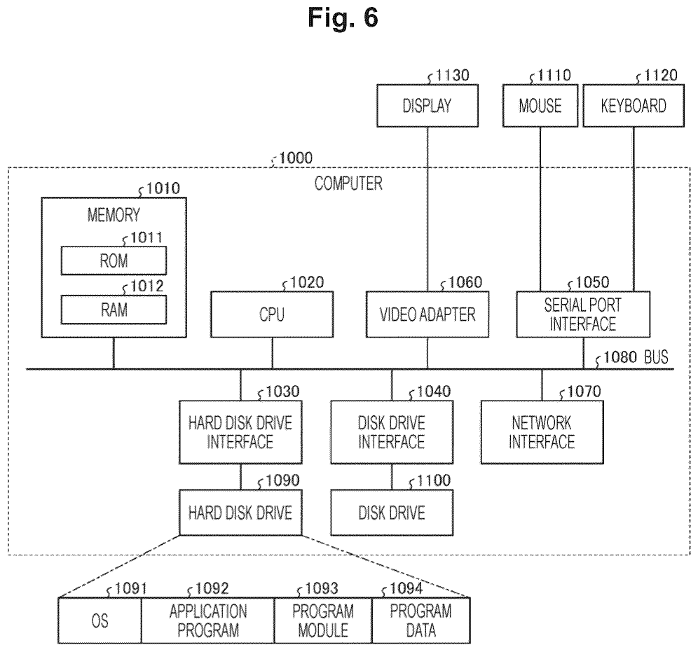

FIG. 6 is a diagram illustrating an example of a computer in which a program is executed and thus the signal processing device 100 is implemented. A computer 1000 includes, for example, a memory 1010 and a CPU 1020. Furthermore, the computer 1000 also includes a hard disk drive interface 1030, a disk drive interface 1040, a serial port interface 1050, a video adapter 1060, and a network interface 1070. These units are connected to each other via a bus 1080.

The memory 1010 includes a ROM 1011 and a RAM 1012. The ROM 1011 stores, for example, a boot program such as a basic input output system (BIOS). The hard disk drive interface 1030 is connected to a hard disk drive 1090. The disk drive interface 1040 is connected to a disk drive 1100. For example, a removable storage medium such as a magnetic disk or an optical disk is inserted into the disk drive 1100. The serial port interface 1050 is connected to, for example, a mouse 1110 and a keyboard 1120. The video adapter 1060 is connected with, for example, a display 1130.

The hard disk drive 1090 stores, for example, an operating system (OS) 1091, an application program 1092, a program module 1093, and program data 1094. That is, the program that defines the processing of the signal processing device 100 is implemented as the program module 1093 in which a code executable by the computer 1000 is described. The program module 1093 is stored in, for example, the hard disk drive 1090. For example, the program module 1093 for executing processing similar to the functional configuration in the signal processing device 100 is stored in the hard disk drive 1090. Note that the hard disk drive 1090 may be replaced with a solid state drive (SSD).

Furthermore, setting data used in the processing of the embodiment is stored as the program data 1094, for example, in the memory 1010 or the hard disk drive 1090. The CPU 1020 reads the program module 1093 and the program data 1094 stored in the memory 1010 and the hard disk drive 1090 to the RAM 1012 as necessary and executes the program module 1093 and the program data 1094.

Note that the program module 1093 and the program data 1094 are not limited to being stored in the hard disk drive 1090, and may be stored in, for example, a removable storage medium and read by the CPU 1020 via the disk drive 1100 or the like. Alternatively, the program module 1093 and the program data 1094 may be stored in another computer connected via a network (local area network (LAN), wide area network (WAN), or the like). The program module 1093 and the program data 1094 may be read by the CPU 1020 from another computer via the network interface 1070.

Although the embodiment to which the invention made by the present inventors is applied has been described above, the present invention is not limited to the description and drawings constituting a part of the disclosure of the present invention according to the present embodiment. That is, other embodiments, examples and operation techniques made by those skilled in the art on the basis of the present embodiment are all included in the scope of the present invention.

### REFERENCE SIGNS LIST

| | |
|---|---|
| 100 | Signal processing device |
| 101-1 to 101-N | Utterance section detection unit |
| 102-1 to 102-N | Voice recognition unit |
| 103 | Wraparound utterance rejection unit |
| 1031 | Same-timing utterance detection unit |
| 1032 | Utterance similarity calculation unit |
| 1033 | Rejection unit |

1. A signal processing device, comprising:
circuitry configured to
receive, together with a voice recognition result of an utterance section of an utterance input to each of a plurality of microphones, an input of time information of a start time and an end time of each utterance and information regarding an appearance time of each word in the voice recognition result;
detect whether or not there is an overlap in time of utterance sections in each pair of voice recognition results of utterances obtained by combining voice recognition results of two utterances from voice recognition results of utterance sections of utterances input to each of the plurality of microphones;
calculate a similarity of voice recognition result for each pair having an overlap in time of utterance sections among pairs of the voice recognition results of the utterances in units of kana or phonemes;
compare the similarity with a predetermined threshold for each pair having an overlap in time of the utterance sections; and
reject an utterance having a shorter length of the voice recognition result as a wraparound utterance for a pair in which the similarity exceeds the threshold.

2. The signal processing device according to claim 1, wherein the circuit calculates the similarity using an overlap ratio of utterance sections for each utterance.

3. The signal processing device according to claim 1, wherein the circuitry calculates the similarity by comparing only portions determined to have been uttered at a same time in the voice recognition results.

4. The signal processing device according to any one of claim 1, wherein the circuitry is further configured to perform voice recognition on a voice in an utterance section of each utterance input to each of the plurality of microphones.

5. The signal processing device according to claim 4, wherein the circuitry is further configured to detect an utterance section in which an utterance exists from a voice of the utterance input to each of the plurality of microphones, and output the voice of the utterance section of each utterance to the voice recognition unit.

6. A signal processing method executed by a signal processing device, the signal processing method comprising:
receiving, together with a voice recognition result of an utterance section of an utterance input to each of a plurality of microphones, an input of time information of a start time and an end time of each utterance and information regarding an appearance time of each word in the voice recognition result;
detecting whether or not there is an overlap in time of utterance sections in each pair of voice recognition results of utterances obtained by combining voice recognition results of two utterances from voice recognition results of utterance sections of utterances input to each of the plurality of microphones;
calculating a similarity of voice recognition results for each pair having an overlap in time of utterance sections among pairs of the voice recognition results of the utterances in units of kana or phonemes;
comparing the similarity with a predetermined threshold for each pair having an overlap in time of the utterance sections; and
rejecting an utterance having a shorter length of the voice recognition result as a wraparound utterance for a pair in which the similarity exceeds the threshold.

7. A non-transitory computer readable medium storing computer executable instructions which, when executed by a computer, cause the computer to execute a process comprising:
receiving, together with a voice recognition result of an utterance section of an utterance input to each of a plurality of microphones, an input of time information of a start time and an end time of each utterance and information regarding an appearance time of each word in the voice recognition result;
detecting whether or not there is an overlap in time of utterance sections in each pair of voice recognition results of utterances obtained by combining voice recognition results of two utterances from voice recognition results of utterance sections of utterances input to each of the plurality of microphones;
calculating a similarity of voice recognition results for each pair having an overlap in time of utterance sections among pairs of the voice recognition results of the utterances in units of kana or phonemes;
comparing the similarity with a predetermined threshold for each pair having an overlap in time of the utterance sections; and
rejecting an utterance having a shorter length of the voice recognition result as a wraparound utterance for a pair in which the similarity exceeds the threshold.
